(19) United States
(12) Patent Application Publication
(10) Pub. No.: US 2024/0228149 A9
(43) Pub. Date: Jul. 11, 2024

(54) BEVERAGE CONTAINER SLEEVE AND METHOD FOR MAKING THE SAME

(71) Applicant: Sleevie, LLC, Covington, LA (US)

(72) Inventor: Thomas Pike Barkerding, Covington, LA (US)

(21) Appl. No.: 18/381,932

(22) Filed: Oct. 19, 2023

Related U.S. Application Data
(60) Provisional application No. 63/417,464, filed on Oct. 19, 2022.

(51) Int. Cl. B65D 81/38; B31B 50/62; B31B 50/73

(52) U.S. Cl. CPC B65D 81/3876; B31B 50/62; B31B 50/73; B31B 2100/00

(57) ABSTRACT

A frustoconical sleeve for receiving a cylindrical or conical beverage container includes a top end, a bottom end, and a central surface area defined between the top end and the bottom end, wherein an exterior perimeter of the central surface area is formed by folding a plurality of perforated perimeter walls such that an upper diameter of the top end is greater than a lower diameter of the bottom end. When folded, the lower diameter of the bottom end of the frustoconical sleeve is narrower than a lower diameter of an inserted cylindrical or conical container forming a lower void between a bottom end of the inserted cylindrical or conical container and a bottom edge of the frustoconical sleeve.

### CROSS-REFERENCE TO RELATED APPLICATIONS

The present application claims the benefit of U.S. Provisional Patent Application No. 63/417,464, filed on Oct. 19, 2022, the entire contents of which are hereby incorporated herein by reference.

### FIELD

The present disclosure relates to beverage container sleeves, and, more specifically, to insulated frustoconical sleeves for use with both conical and cylindrical beverage containers.

### BACKGROUND

Beverage container sleeves are typically utilized to insulate a user's hand from a beverage container and, in turn, to simultaneously insulate the beverage container from the user's hand. Some non-limiting examples of beverage sleeves categories include frustoconical sleeves intended for conical containers (e.g., coffee cup sleeves) and cylindrical sleeves intended for cylindrical containers (e.g., koozies). For example, many coffee shops use frustoconical paper sleeves in lieu of cocktail napkins to insulate hot and cold drinks, as consumers may be averse to hot, cold and/or wet hands resulting from holding their beverage.

Shape is critical when considering the viability of a beverage sleeve container. For example, in contrast to coffee shops that sell conical containers (e.g., coffee cups), bars typically sell beverages in cylindrical containers (e.g., bottles), in addition to conical containers (e.g., pint glasses). Unlike a paper coffee cup sleeve, which relies on its frustoconical shape to support containers with a corresponding gradient, cylinders require a physical bottom for support, which adds complexity and thus, cost to manufacturing. Additionally, while the geometric reciprocity between a frustoconical sleeve and frustoconical container makes it possible for one single size frustoconical sleeve to sufficiently accommodate multiple cup sizes, the typical diametric variance among cylindrical on-premises beverage containers makes it impossible for one single size cylindrical paper sleeve to securely fit multiple cylindrical container sizes.

This challenge is complicated by the materials currently available. For example, users may have difficulty applying the concept of a cylindrical beverage container, such as a koozie, to a relatively inflexible material such as paper. Since paper does not easily stretch like neoprene or other koozie substrates, the only reasonably viable way to offer a cylindrical paper sleeve that properly fits the varying width among cylindrical containers is by having a separate sleeve size for every diameter, which is a complicated and inefficient proposition. Some users may require a beverage container sleeve that can hold both a conical container and a cylindrical container. Currently, there does not exist a categorical hybrid wherein frustoconical sleeves are intended for both conical and cylindrical beverage containers, as frustoconical sleeves on the market today cannot reasonably accommodate cylindrical containers.

Accordingly, there is a need for a categorical hybrid frustoconical sleeve, which is intended for use with both conical and cylindrical beverage containers.

### SUMMARY

This disclosure relates to a frustoconical sleeve for receiving a cylindrical or conical beverage container. The frustoconical sleeve includes a top end, a bottom end, and a central surface area defined between the top end and the bottom end, wherein an exterior perimeter of the central surface area is formed by folding a plurality of perforated perimeter walls. Further, an upper diameter of the top end is greater than a lower diameter of the bottom end and the lower diameter of the bottom end of the frustoconical sleeve is narrower than a lower diameter of an inserted cylindrical or conical container, forming a lower void between a bottom end of the inserted cylindrical or conical container and a bottom edge of the frustoconical sleeve.

In accordance with aspects of the disclosure, the frustoconical sleeve may further be comprised of a plurality of perforated perimeter walls defining the exterior perimeter of the central surface area of the frustoconical sleeve, whereby, the plurality of perforated perimeter walls expand the exterior perimeter of the central surface area of the frustoconical sleeve in partial conformance to a wider diameter of the inserted cylindrical or conical container, leaving the upper and the lower diameter of the frustoconical sleeve unaltered, in response to an inserted cylindrical or conical container with a wider diameter than the lower diameter of the frustoconical sleeve.

In an aspect of the present disclosure, the frustoconical sleeve may be formed from a unitary piece of material.

In another aspect of the present disclosure, the frustoconical sleeve may further include a plurality of buttress tabs disposed thereon and configured to further secure, stabilize, and/or insulate the inserted cylindrical or conical container.

In yet another aspect of the present disclosure, a plurality of attachment surfaces of one or more identical frustoconical sleeves may be attached to the unitary piece of material to form a multi-pack of identical frustoconical sleeves.

In a further aspect of the present disclosure, the plurality of attachment surfaces of the one or more identical frustoconical sleeves may be attached to the unitary piece of material by an adhesive material.

In yet a further aspect of the present disclosure, the plurality of attachment surfaces of the one or more identical frustoconical sleeves may be detached from the unitary piece of material either by perforation, partial cut, print, tearing, or cutting of the plurality of attachment surfaces, thereby maintaining the structural integrity of the one or more identical frustoconical sleeves.

In accordance with aspects of the disclosure, a method of assembling a frustoconical sleeve includes: forming a three-dimensional frustoconical sleeve by engaging opposing top ends and bottom ends of a frustoconical sleeve to one another to define a bottom crevice whereby a lower void exists between a bottom end of an inserted cylindrical or conical container and a bottom edge of the frustoconical sleeve, and attaching the opposing top ends and bottom ends of material to each other by applying adhesive to at least one of the opposing top and bottom ends.

In yet another aspect of the present disclosure, the frustoconical sleeve may be formed from a unitary piece of material.

In another aspect of the present disclosure, at least one fold along a perforated perimeter wall of the frustoconical sleeve may be created to attach the opposing top ends and bottom ends of the frustoconical sleeves.

In a further aspect of the present disclosure, a plurality of attachment surfaces may be attached to the frustoconical sleeve to enable multi-pack engagement of identical frustoconical sleeves.

In yet another aspect of the present disclosure, the plurality of attachment surfaces may include an adhesive material.

In an aspect of the present disclosure, the plurality of attachment surfaces include interlocking tabs, structured board, or non-adhesive materials.

In a further aspect of the present disclosure, at least one of the plurality of attachment surfaces may be detached from the unitary piece of material by perforation, partial cut, print, tearing, or cutting of the at least one of the plurality of attachment surfaces, while maintaining the structural integrity of the frustoconical sleeve.

In another aspect of the present disclosure, at least two aligned sections of material partially cut on three sides from within opposing walls of the frustoconical sleeve may be attached to one another, whereby, upon opening the frustoconical sleeve, the aligned sections hinge inwardly from the opposing walls of the frustoconical sleeve to form a horizontal bottom end whereby an inserted cylindrical or conical container is supported and therein prevented from passing through the frustoconical sleeve.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1 is a perspective view of a frustoconical sleeve, in accordance with aspects of the present disclosure;

FIGS. 2A-2C illustrate steps for assembling the frustoconical sleeve of FIG. 1;

FIG. 3 is a perspective view of frustoconical sleeve of FIG. 1 including a bottom opening;

FIGS. 4A-4D are exemplary illustrations of the frustoconical sleeve of FIG. 1 sized to fit various beverage containers;

FIG. 5 is a perspective view of a frustoconical sleeve, in accordance with aspects of the present disclosure;

FIGS. 6A-6C illustrate steps for assembling the frustoconical sleeve of FIG. 5;

FIGS. 7A-7C are exemplary illustrations of the frustoconical sleeve of FIG. 5 sized to fit various beverage containers;

FIG. 8 is a perspective view of the frustoconical sleeve of FIG. 5 including buttress tabs;

FIGS. 9A-9C illustrate steps for assembling the frustoconical sleeve of FIG. 8;

FIG. 10 is a perspective view of a frustoconical sleeve, in accordance with aspects of the present disclosure;

FIGS. 11A-11C illustrate steps for assembling the frustoconical sleeve of FIG. 10;

FIGS. 12A-12C illustrate steps for assembling the frustoconical sleeve of FIG. 10 including two individual pieces of material;

FIG. 13 is a top view of the frustoconical sleeve of FIG. 10 formed in a carton;

FIG. 14 is a perspective view of a frustoconical sleeve, in accordance with aspects of the present disclosure;

FIGS. 15A-15C illustrate steps for assembling the frustoconical sleeve of FIG. 14;

FIG. 16 is a perspective view of a multi-pack of frustoconical sleeves, in accordance with aspects of the present disclosure;

FIGS. 17A-17D illustrate steps for assembling the multi-pack of frustoconical sleeves of FIG. 16; and

FIGS. 18A-18B are exemplary illustrations of the multi-pack of frustoconical sleeves of FIG. 16 holding beverage containers.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

The beverage container sleeve disclosed herein introduces a frustoconical sleeve for both conical and cylindrical beverage containers. This categorical hybrid addresses the need for a versatile sleeve that accommodates various shaped containers. For example, if a cylindrical 12 oz. aluminum can is inserted into a frustoconical coffee cup sleeve, it will fall through because said sleeve is intended to accommodate the wider diameter of frustoconical containers (e.g., cups), not cylinders. This beverage container sleeve provides a solution to accommodate the wider diameter of frustoconical containers.

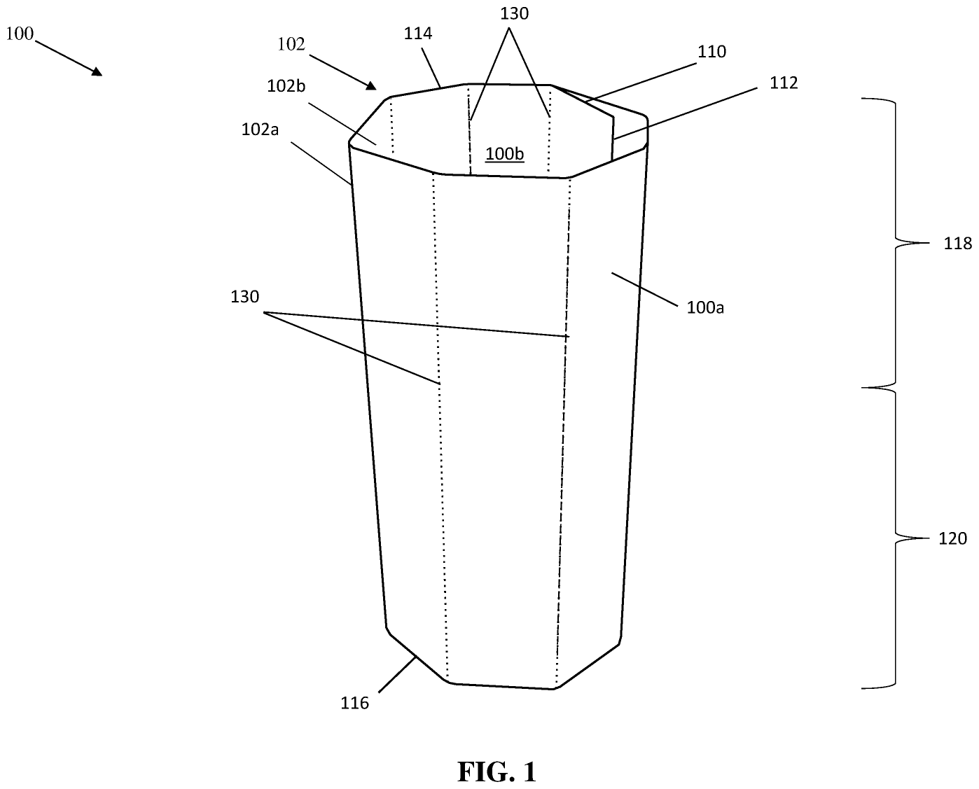

Referring to FIG. 1, a frustoconical sleeve 100 provided in accordance with the present disclosure generally includes a body 102 having an outer surface 100a and an inner surface 100b. Body 102 includes a first end 110, a second end 112, a top edge 114, a bottom edge 116, an upper section 118, and a lower section 120. The upper section 118 and lower section 120 may define a central surface area. Fold lines 130 (e.g., score lines or perforations) may be formed in body 102 to indicate lines along which a user folds body 102 to assemble frustoconical sleeve 100. Top edge 114 and bottom edge 116 may, in an unassembled state, extend outwards horizontally, defining an axis X. Fold lines 130 may extend longitudinally in a direction perpendicular to axis X, defining an axis Y. In the unassembled state, first end 110 and second end 112 may be diametrically opposed ends running in a direction parallel to axis Y.

Body 102 may be fabricated from any number of accessible materials, including paper, paperboard, embossed paperboard, cardboard, chipboard, posterboard, polystyrene foam, fabric, balsa wood, corrugated cardboard, single or double face fluted paper, corrugated plastic, plastic sheeting, neoprene, foam rubber, or any combination thereof. In aspects, body 102 made be made of a waterproof or water-resistant material to prevent buildup of condensation.

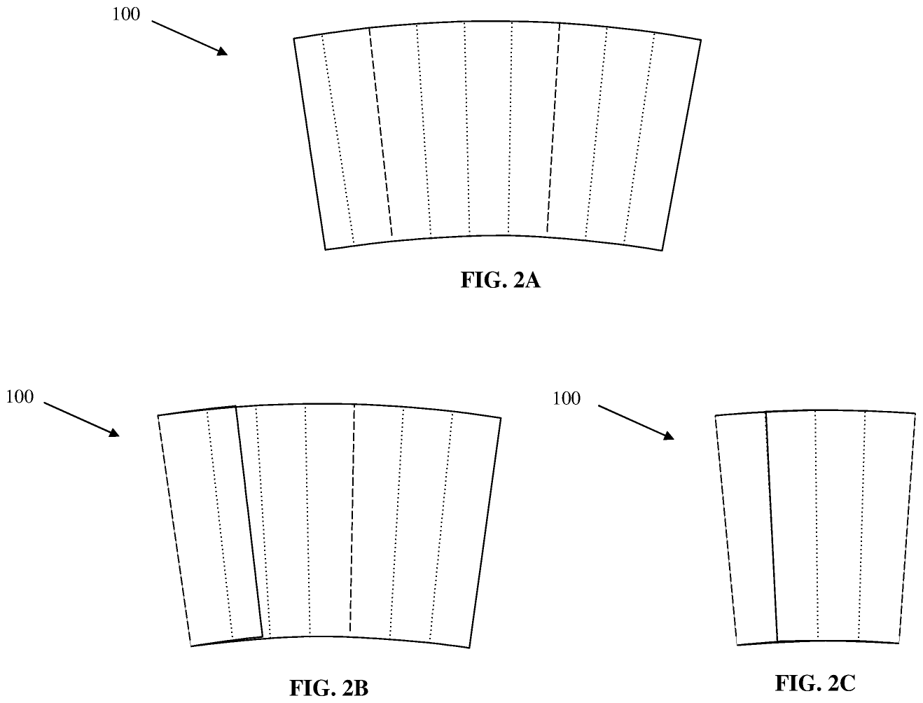

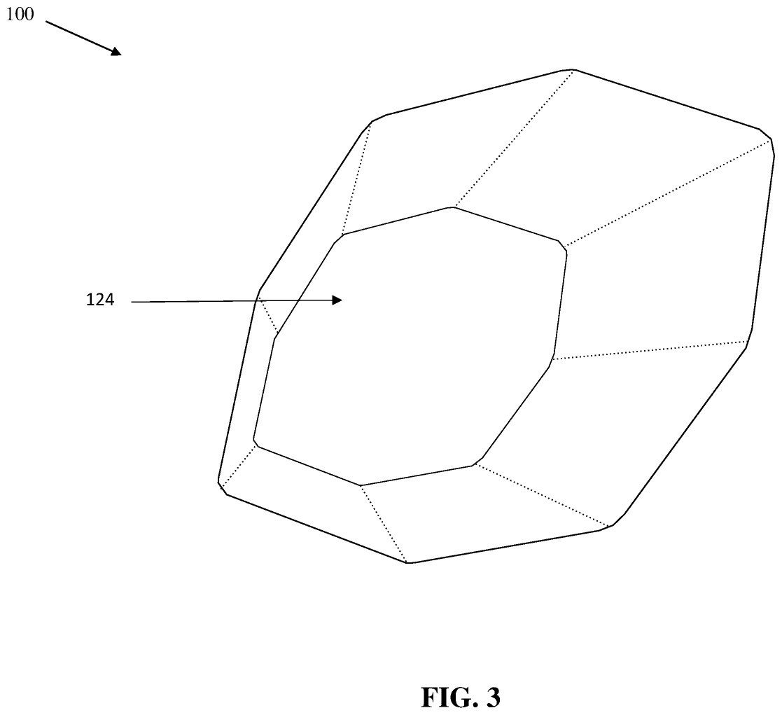

Referring to FIGS. 2A-2C, steps for assembling frustoconical sleeve 100 are illustrated. Generally, body 102 may be fabricated from a single material and assembled by connecting first end 110 and second end 112. At least one of first end 110 and second end 112 may contain an adhesive to connect first end 110 to second end 112. To assemble frustoconical sleeve 100, a user may begin by folding along a first fold line 130. Next, a user may fold the resulting folded body 102 again over the next fold line 130. This process will iterate until first end 110 and second end 112 meet. For example, the outer surface 102a of first end 110 may adhere to an inner surface 102b of second end 112 (FIG. 1), forming the resulting shape of frustoconical sleeve 100 and forming bottom opening 124 (FIG. 3). In the assembled state, frustoconical sleeve 100 tapers inward such that the diameter of the lower section 120 is smaller than a diameter of the upper section 118 (FIG. 1)

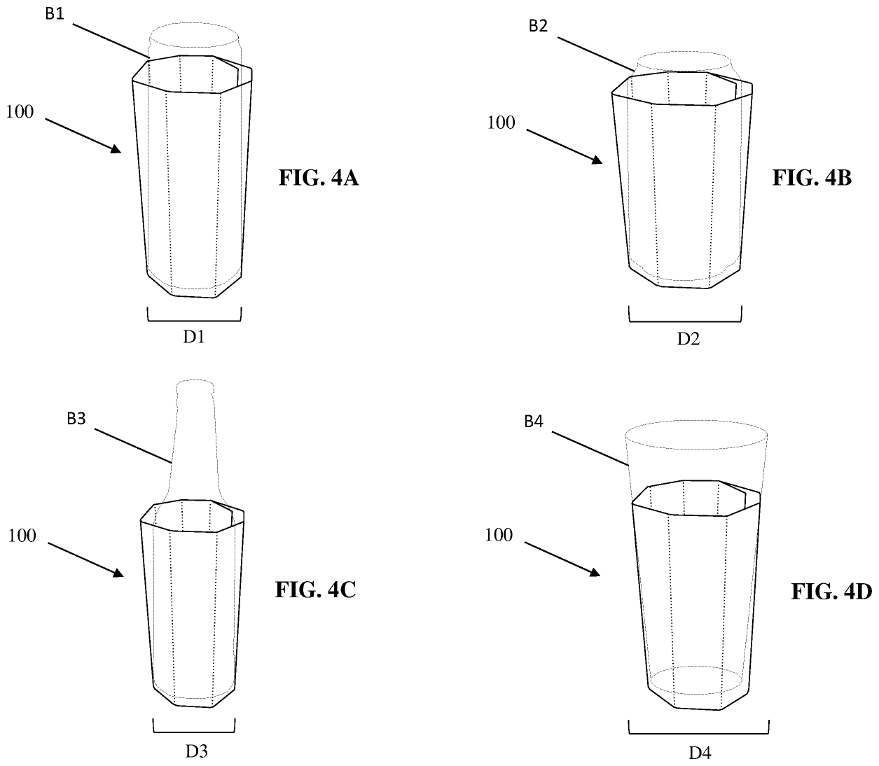

Referring to FIGS. 4A-4D, exemplary illustrations of frustoconical sleeve 100 sized to fit various beverage containers are shown. Based on how frustoconical sleeve 100 is assembled, it is configured to hold beverage containers B1, B2, B3, and B4, of varying shapes (e.g., cylindrical and frustoconical) and diameters D1, D2, D3, and D4 respectively. For example, B1 may be a narrow can, B2 may be a wide can or coffee cup, B3 may be a beer glass, and B4 may be a pint glass. Because lower portion 120 tapers inward and extends below beverage containers B1, B2, B3, and B4, a diameter at the bottom of lower portion 120 (e.g., diameter of bottom edge 116) may be smaller than a diameter of the bottom of beverage container B1, B2, B3, and B4. As a result, beverage container B1, B2, B3, and B4 may be held securely and/or supported within frustoconical sleeve 100 so as to not fall through bottom opening 124. As a result, frustoconical sleeve 100 does not require a bottom wall for support, making it less complex and more efficient to produce, distribute, store, serve, and/or use.

Because beverage containers B1, B2, B3, and B4 remain suspended within frustoconical sleeve 100, any surface that frustoconical sleeve 100 is placed on may be protected from moisture (e.g., condensation). The snug fit of frustoconical sleeve 100 may maintain a predominating surface temperature above dew point, such that water vapor is less likely to form and latent heat generated by condensation is reduced. This permits a rigid material (e.g., eighteen-point, unbleached sulfate paperboard) to reduce the formation of condensation on the beverage containers B1, B2, B3, and B4, and thereby maintain a cooler temperature of a beverage while keeping frustoconical sleeve 100 clean and comfortable to hold by a user.

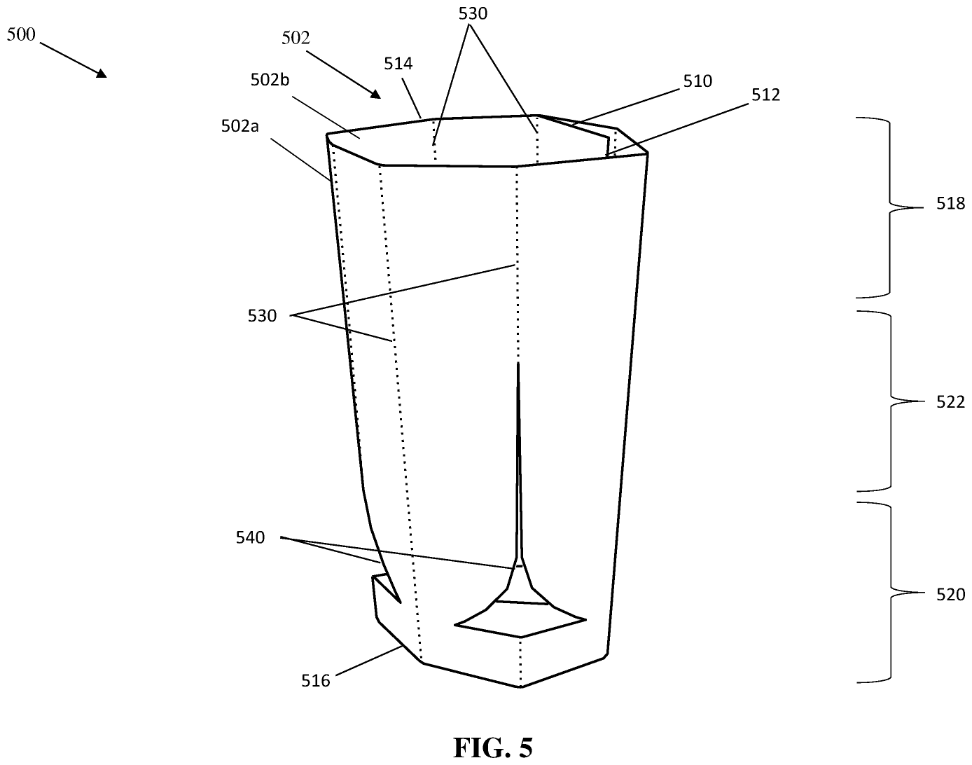

Now referring to FIG. 5, a frustoconical sleeve 500 provided in accordance with the present disclosure generally includes a body 502 having an outer surface 500a and an inner surface 500b. Frustoconical sleeve 500 is similar to frustoconical sleeve 100, and for brevity, primarily the differences will be discussed.

Body 502 includes a first end 510, a second end 512, a top edge 514, a bottom edge 516, an upper section 518, lower section 520, and middle section 522. Fold lines 530 (e.g., score lines or perforations) may be formed in body 502 to indicate lines along which a user folds body 502 to assemble frustoconical sleeve 500. Slots 540 may be formed in middle section 522. As shown in FIG. 5, slots 540 may be vertical slots extending in a longitudinal direction.

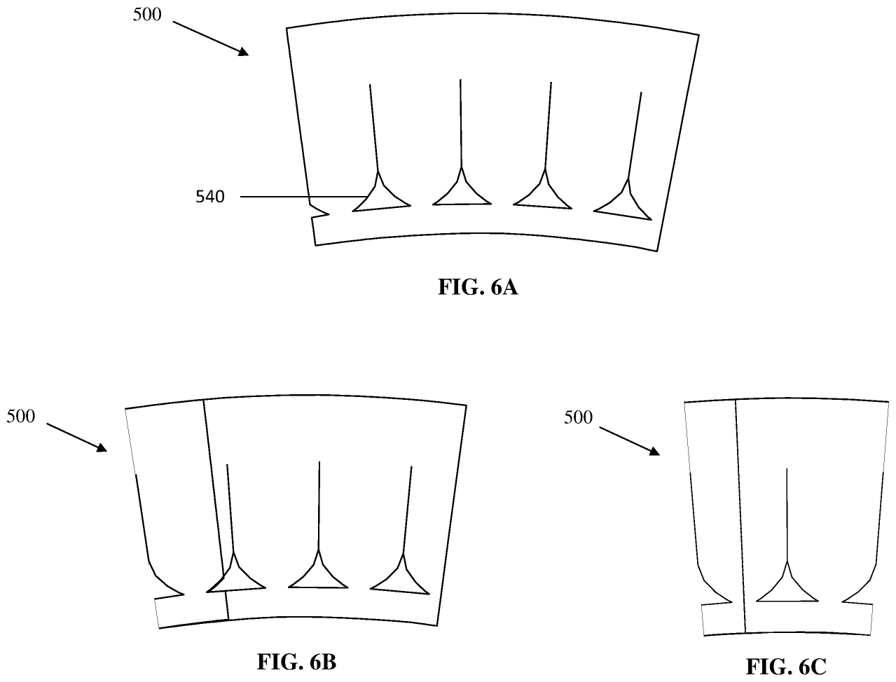

Referring to FIGS. 6A-6C, steps for assembling frustoconical sleeve 500 are illustrated. Generally, body 502 may be fabricated from a single material and assembled by connecting first end 510 and second end 512. In aspects, body 502 may be a paperboard cut. At least one of first end 510 and second end 512 may contain an adhesive to connect first end 510 to second end 512. To assemble frustoconical sleeve 500, a user may begin by folding along a first fold line 530. Next, a user may fold the resulting folded body 502 again over the next fold line 530. This process will iterate until first end 510 and second end 512 meet. For example, the outer surface 502a of first end 510 may adhere to an inner surface 502b of second end 112 (FIG. 5), forming the resulting shape of frustoconical sleeve 500. Similar to frustoconical sleeve 100, frustoconical sleeve 500 may include a bottom opening (not shown). Frustoconical sleeve 500 may be assembled such that a bottom of each slot 540 expands. Slots 540 may be rectangular shaped, forming triangular-shaped expansions at a bottom portion. However, it will be understood by one skilled in the art that various shapes, numbers, and configurations of slots 540 are contemplated by this disclosure. In the assembled state, frustoconical sleeve 500 tapers inward such that the diameter of the lower section 520 is smaller than a diameter of the middle section 522, and a diameter or the middle section 522 is less than a diameter of the upper section 518 (FIG. 1).

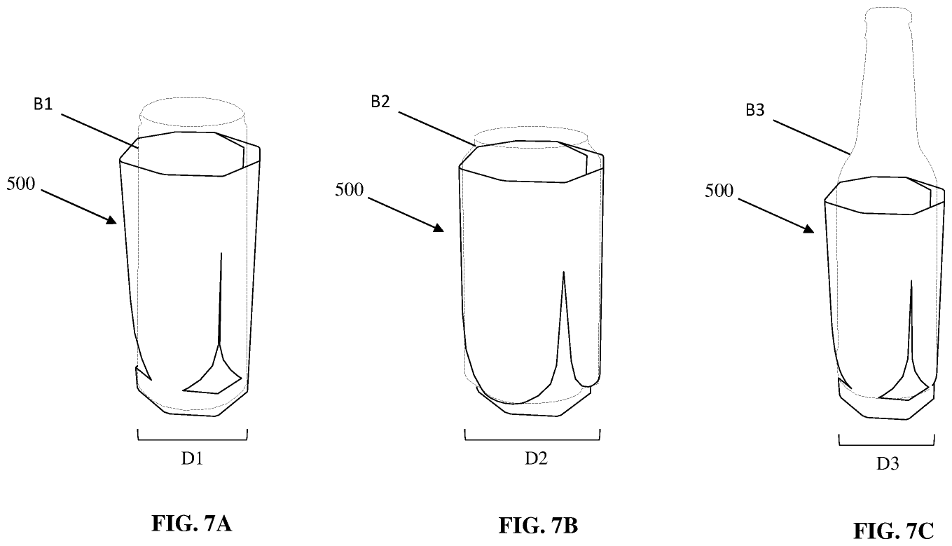

Referring to FIGS. 7A-7C, exemplary illustrations of frustoconical sleeve 500 sized to fit various beverage containers are shown Similar to frustoconical sleeve 100, based on how frustoconical sleeve 500 is assembled, it is configured to hold beverage containers B1, B2, and B3, of varying shapes (e.g., cylindrical and frustoconical) and diameters D1, D2, and D3, respectively. Because lower portion 520 tapers inward and extends below beverage containers B1, B2, and B3, a diameter at the bottom of lower portion 520 (e.g., diameter of bottom edge 516) may be smaller than a diameter of the bottom of beverage container B1, B2, and B3. As a result, beverage container B1, B2, and B3 may be held securely and/or supported within frustoconical sleeve 500. Slots 540, in combination with the tapering of frustoconical sleeve 500, may enable the middle section 522 of frustoconical sleeve 500 to expand and contract in conformance with a diameter of beverage container B1, B2, and B3, without altering the diameter of the upper section 518 or the lower section 522. In doing so, frustoconical sleeve 500 may be configured to adapt to a size and/or shape of any beverage container inserted therein.

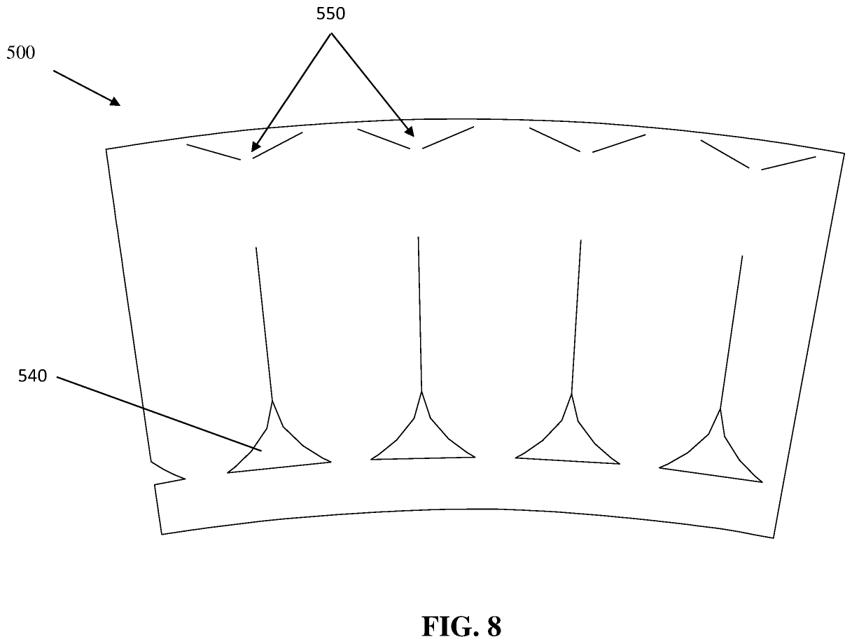

Now referring to FIG. 8, tabs 550 may be formed in frustoconical sleeve 500. Tabs 550 may be formed along top edge 514 and may be configured to create indentations, pressing against a beverage container. Tabs 550 may be configured to further secure, stabilize, and insulate a beverage container inside frustoconical sleeve 500. In aspects, tabs 500 may be buttress tabs. While four tabs 550 are shown, it will be understood by one skilled in the art that various shapes, numbers, and configurations of tabs 550 are contemplated by this disclosure.

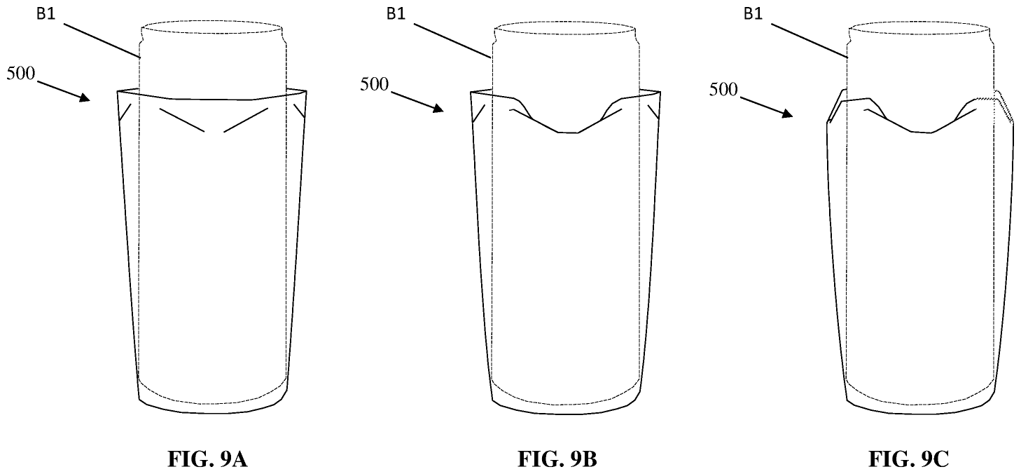

Referring to FIGS. 9A-9C, tabs 550 may be engaged by a user to further secure beverage B1 inside frustoconical sleeve 500. To do so, a user may engage tabs along the upper top edge 514 by pressing inward, creating indentations. A user may continue until the desired number of tabs 550 are indented.

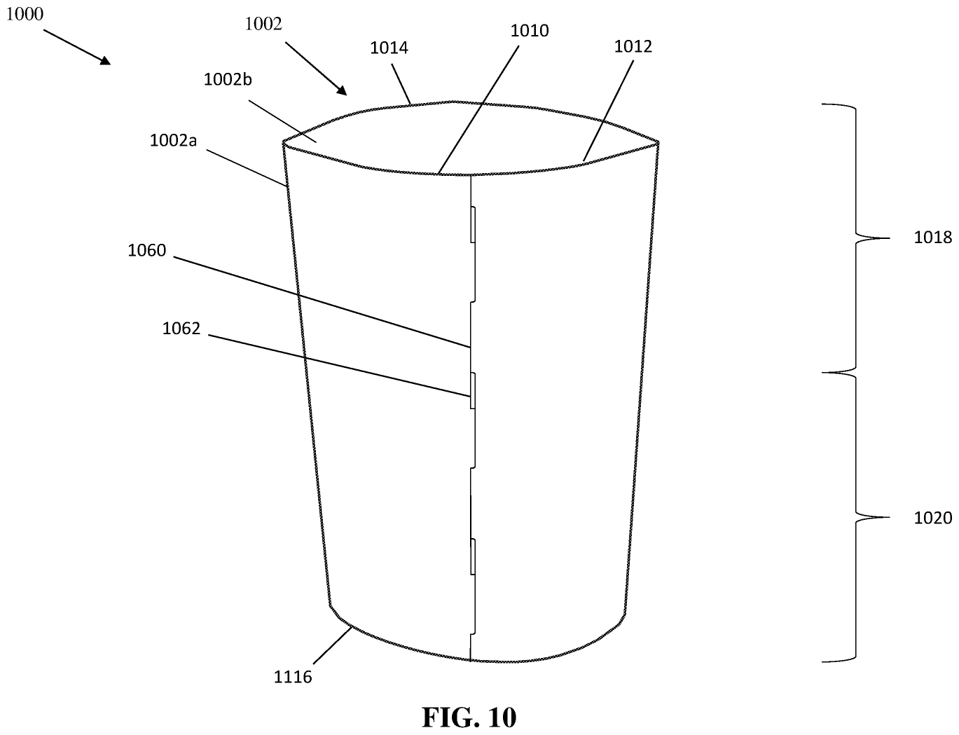

Now referring to FIG. 10, a frustoconical sleeve 1000 provided in accordance with the present disclosure generally includes a body 1002 having an outer surface 1000a and an inner surface 1000b. Frustoconical sleeve 1000 is similar to frustoconical sleeves 100, 500, and for brevity, primarily the differences will be discussed.

Body 1002 includes a first end 1010, a second end 1012, a top edge 1014, a bottom edge 1016, an upper section 1018, and a lower section 1020. Fold lines 1030 (e.g., score lines or perforations) may be formed in body 1002 to indicate lines along which a user folds body 1002 to assemble frustoconical sleeve 1000. Interlocking tabs 1060 and slots 1062 may be formed in body 1002 along the first end 1010 and/or second end 1020. As shown in FIG. 10, slots 1062 may be vertical slots extending in a longitudinal direction.

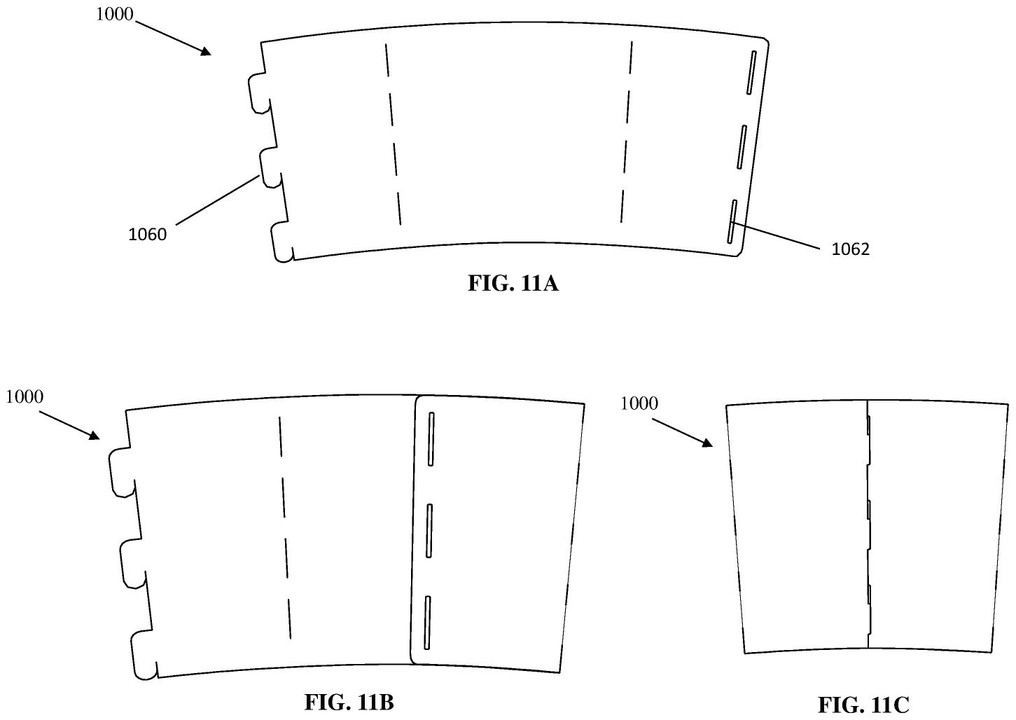

Referring to FIGS. 11A-11C, steps for assembling frustoconical sleeve 1000 are illustrated. Generally, body 1002 may be fabricated from a single material and assembled by connecting first end 1010 and second end 1012. To assemble frustoconical sleeve 1000, a user may begin by folding along a first fold line 1030. Next, a user may fold the resulting folded body 1002 again over the next fold line 1030. This process will iterate until first end 1010 and second end 1012 meet. Then, interlocking tabs 1060 may be inserted into corresponding slots 1062, securing the first end 1010 to the second end 1012 and forming the resulting shape of frustoconical sleeve 1000. Similar to frustoconical sleeve 100, frustoconical sleeve 1000 may include a bottom opening (not shown). Three interlocking tabs 1060 and slots 1062 are shown. However, it will be understood by one skilled in the art that various shapes, numbers, and configurations of interlocking tabs 1060 and slots 1062 are contemplated by this disclosure. In the assembled state, frustoconical sleeve 1000 tapers inward such that the diameter of the lower section 1020 is smaller than a diameter of the upper section 1018 (FIG. 10).

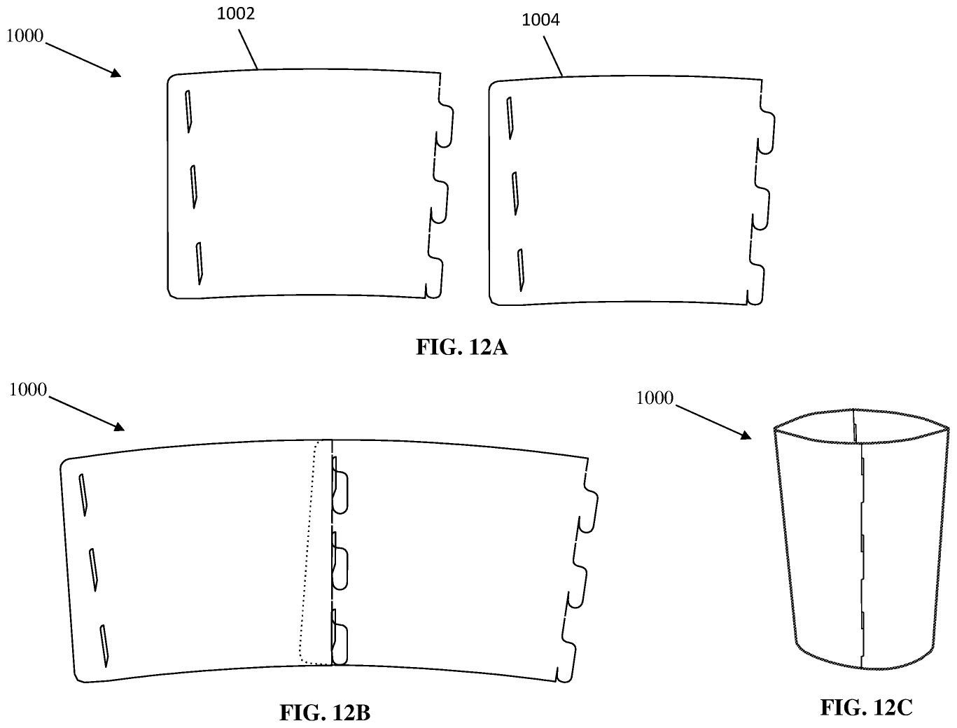

Referring to FIGS. 12A-12C, frustoconical sleeve 1000 may be fabricated from two pieces of material 1002 and 1004, each containing a set of interlocking tabs 1060 and slots 1062, eliminating the need to use an adhesive. To assemble frustoconical sleeve 1000, a user may insert the interlocking tabs 1060 of material 1002 into the slots 1062 of material 1004. Next, the user may insert the interlocking tabs 1060 of material 1004 into the slots 1062 of material 1002, securing material 1002 to material 1004 and forming the resulting shape of frustoconical sleeve 1000. It is contemplated that other frustoconical sleeves, such as frustoconical sleeves 100, 500 of this disclosure, may also be formed from two materials similar to 1002 and 1004, which may be affixed in any manner (e.g., adhesive).

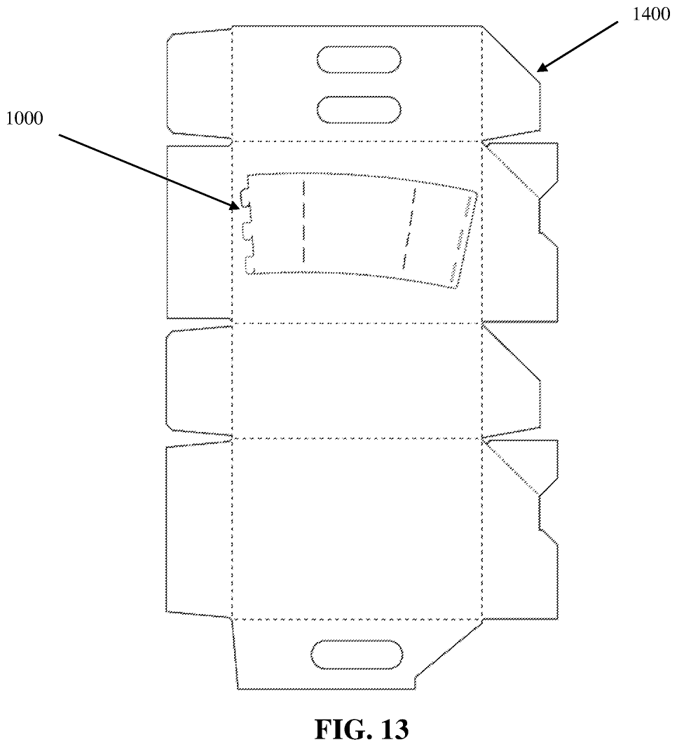

Referring to FIG. 13, frustoconical sleeve 1000 may be formed in a carton 1400, such as a multi-pack carton (e.g., twelve pack beverage container). Unassembled frustoconical sleeve 1000 may be removably affixed to carton 1400, including a guide for removal such as printing, perforation, or other indentation configured to tear, punch, cut out and/or detach the unassembled frustoconical sleeve 1000 from carton 1400 for assembly and use.

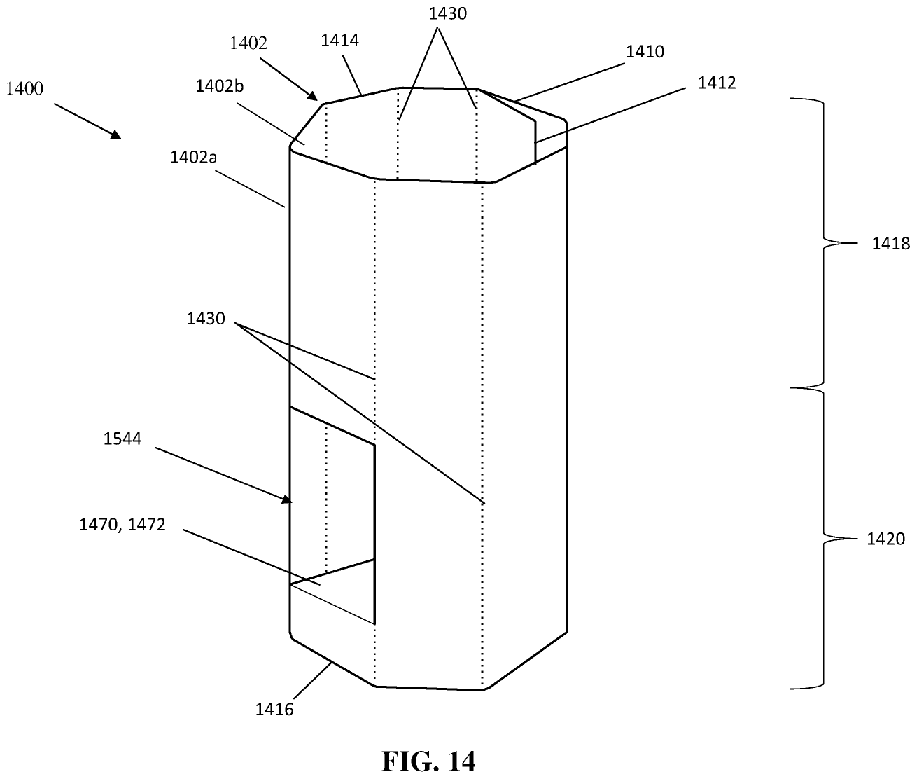

Now referring to FIG. 14, a frustoconical sleeve 1400 provided in accordance with the present disclosure generally includes a body 1402 having an outer surface 1400a and an inner surface 1400b. Frustoconical sleeve 1400 is similar to frustoconical sleeves 100, 500, and 1000, for brevity, primarily the differences will be discussed.

Body 1402 includes a first end 1410, a second end 1412, a top edge 1414, a bottom edge 1416, an upper section 1418, and a lower section 1420. Fold lines 1430 (e.g., score lines or perforations) may be formed in body 1402 to indicate lines along which a user folds body 1402 to assemble frustoconical sleeve 1400. Support tabs 1470 may be formed in body 1402, which when engaged may form bottom support 1472 and body openings 1474. As shown in FIG. 14, support tabs may be vertical slots extending in a longitudinal direction.

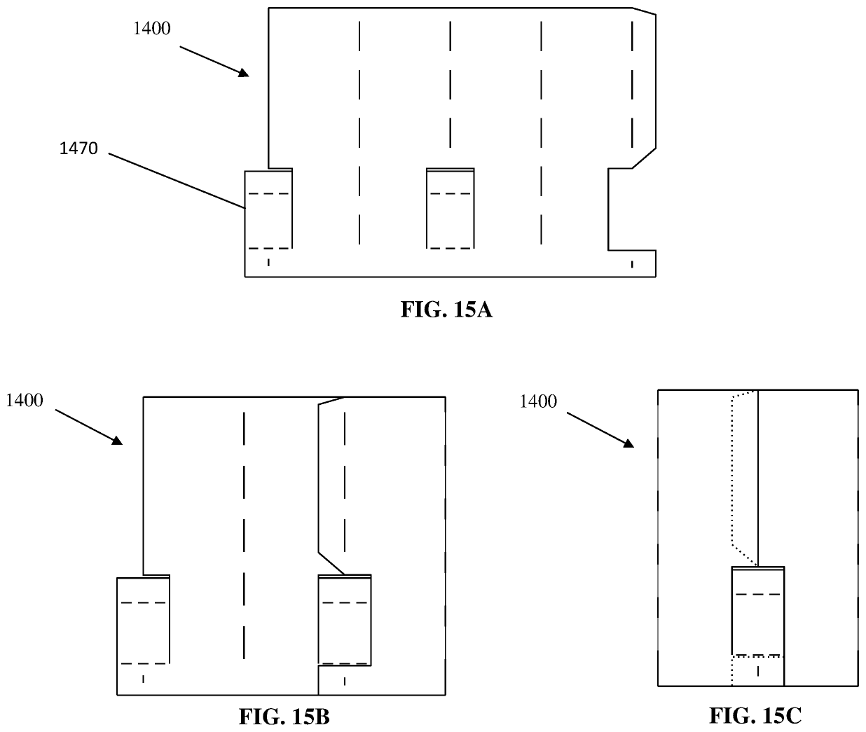

Referring to FIGS. 15A-15C, steps for assembling frustoconical sleeve 1400 are illustrated. Generally, body 1402 may be fabricated from a single material and assembled by connecting first end 1410 and second end 1412. To assemble frustoconical sleeve 1400, a user may begin by folding along a first fold line 1430. Next, a user may fold the resulting folded body 1402 again over the next fold line 1430. This process will iterate until first end 1410 and second end 1412 meet forming the resulting shape of frustoconical sleeve 1400. Then, support tabs 1470 may be pressed inward, extending into the center of frustoconical sleeve 1400 from inner surface 1400b. Pressing inward releases the support tabs, which may be released via perforation, a partial cut, print, tearing, and/or cutting, while maintaining the structural integrity of the frustoconical sleeve 1400. Support tabs 1470 may therefore hinge inwardly, acting as attached surfaces to create a horizontal bridge connecting to and extending from opposing sides of frustoconical sleeve 1400 to support a beverage container. Engagement of support tabs 1470 subsequently forms body openings 1474. As support tabs 1470 connect on inner surface 1400b, they may form bottom support 1472. Support tabs 1470 may be connected by adhesive, interlocking tabs (not shown), or another connection method. In aspects, support tabs 1470 may ne diametrically opposed pairs of tabs. However, it will be understood by one skilled in the art that various shapes, numbers, and configurations of support tabs 1470 are contemplated by this disclosure. In the assembled state, frustoconical sleeve 1400 tapers inward such that the diameter of the lower section 1420 is smaller than a diameter of the upper section 1418 (FIG. 14).

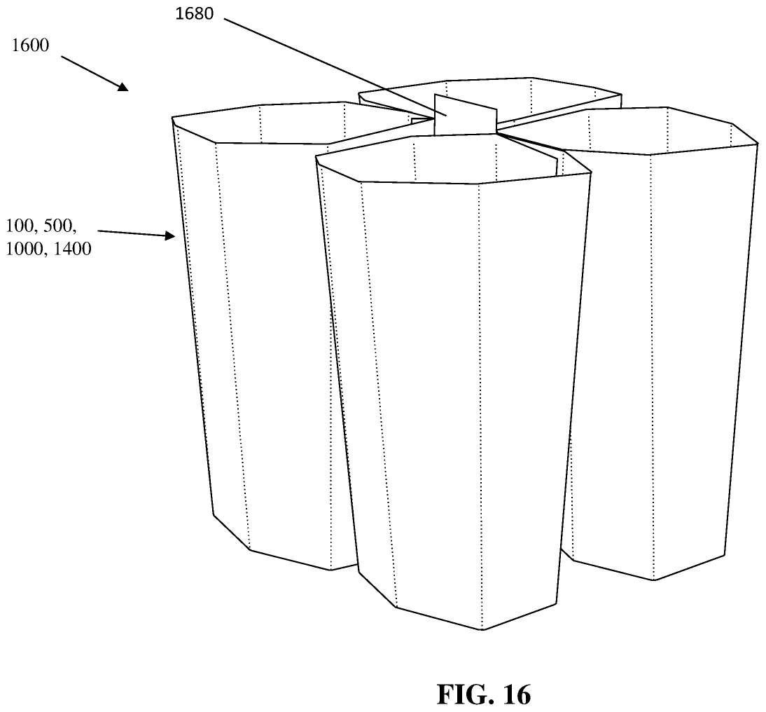

Now referring to FIG. 16, a multi-pack of frustoconical sleeves 1600 provided in accordance with the present disclosure generally includes a plurality of frustoconical sleeves 100, 500, 1000, and/or 1400.

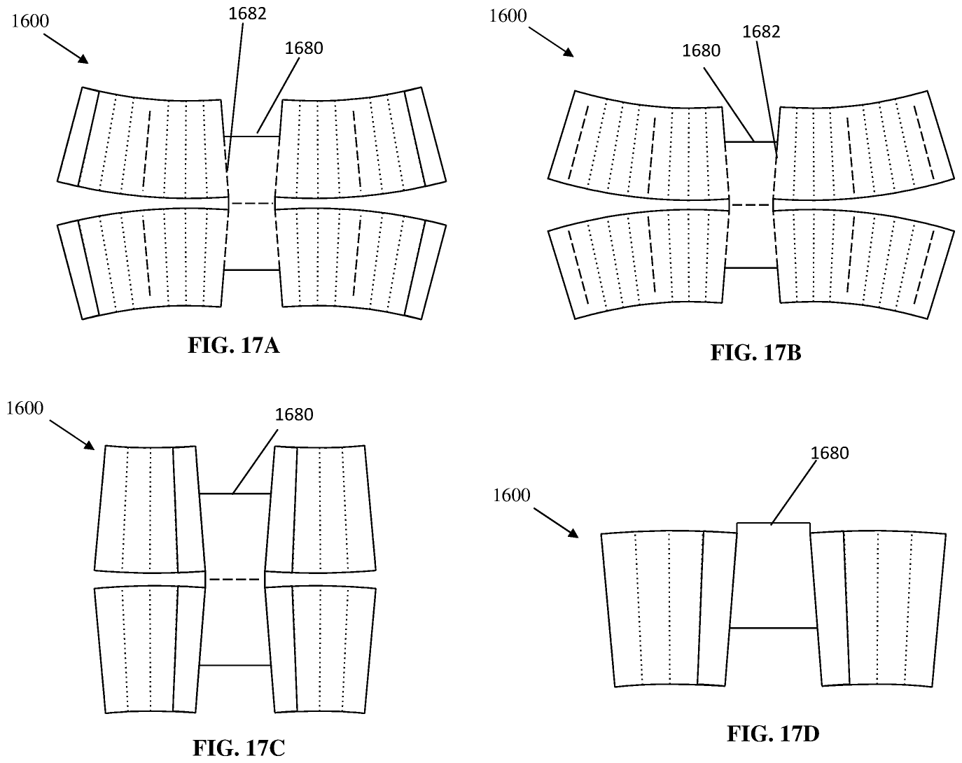

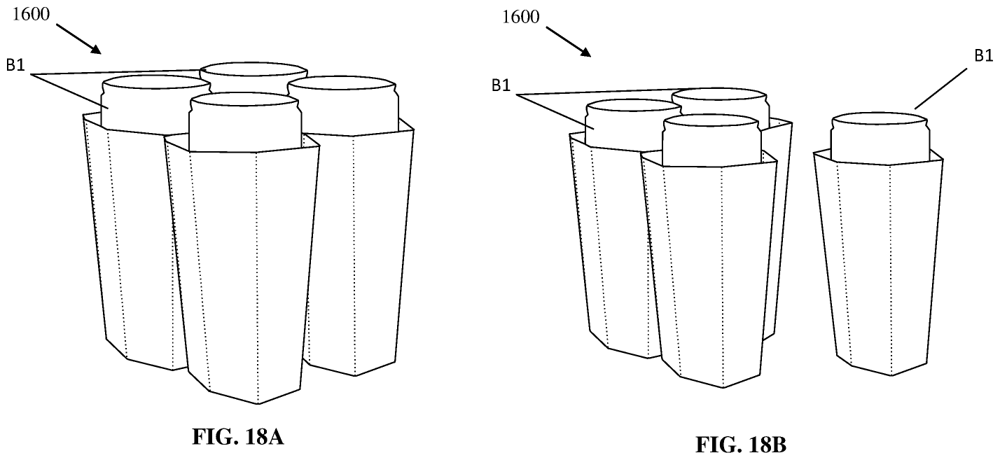

Referring to FIGS. 17A-17D, steps for assembling multi-pack of frustoconical sleeves 1600 are illustrated. First, each frustoconical sleeves 100, 500, 1000, and/or 1400 may be assembled in accordance with the disclosure herein. Next, each frustoconical sleeves 100, 500, 1000, and/or 1400 may be oriented upward. The frustoconical sleeves 100, 500, 1000, and/or 1400 may be connected by tab 1680 (i.e., an attachment surface) and may be separated individually by perforations 1682. Alternative methods of separation such as a partial cut, print, tearing, or cutting are envisioned. In aspects, the tabs may be releasably coupled to the frustoconical sleeves 100, 500, 1000, and/or 1400, so that they may be attached/reattached. After detaching one of the frustoconical sleeves 100, 500, 1000, and/or 1400, the structural integrity of the multi-pack of frustoconical sleeves 1600 is maintained. FIGS. 18A and 18B are exemplary uses of the multi-pack of frustoconical sleeves 1600.

While several aspects of the disclosure have been shown in the drawings and/or described herein, it is not intended that the disclosure be limited thereto, as it is intended that the disclosure be as broad in scope as the art will allow and that the specification be read likewise. Therefore, the above description should not be construed as limiting, but merely as exemplifications of particular aspects. Those skilled in the art will envision other modifications within the scope of the claims appended hereto.

What is claimed is:

1. A frustoconical sleeve for receiving a cylindrical or conical beverage container, the frustoconical sleeve comprising:
a top end;
a bottom end; and
a central surface area defined between the top end and the bottom end, wherein an exterior perimeter of the central surface area is formed by folding a plurality of perforated perimeter walls such that an upper diameter of the top end is greater than a lower diameter of the bottom end,
wherein the lower diameter of the bottom end of the frustoconical sleeve is narrower than a lower diameter of an inserted cylindrical or conical container forming a lower void between a bottom end of the inserted cylindrical or conical container and a bottom edge of the frustoconical sleeve.

2. The frustoconical sleeve of claim 1, further comprising a plurality of perforated perimeter walls defining the exterior perimeter of the central surface area of the frustoconical sleeve, whereby, the plurality of perforated perimeter walls expand the exterior perimeter of the central surface area of the frustoconical sleeve in partial conformance to a wider diameter of the inserted cylindrical or conical container, leaving the upper and the lower diameters of the frustoconical sleeve unaltered, in response to an inserted cylindrical or conical container with a wider diameter than the lower diameter of the frustoconical sleeve.

3. The frustoconical sleeve of claim 1, wherein the frustoconical sleeve is formed from a unitary piece of material.

4. The frustoconical sleeve of claim 1, wherein the frustoconical sleeve further comprises a plurality of buttress tabs disposed thereon and configured to further secure, stabilize, and/or insulate the inserted cylindrical or conical container.

5. The frustoconical sleeve of claim 3, wherein a plurality of attachment surfaces of one or more identical frustoconical sleeves are attached to the unitary piece of material to form a multi-pack of identical frustoconical sleeves.

6. The frustoconical sleeve of claim 5, wherein the plurality of attachment surfaces of the one or more identical frustoconical sleeves attaches to the unitary piece of material by an adhesive material.

7. The frustoconical sleeve of claim 6, wherein the plurality of attachment surfaces of the one or more identical frustoconical sleeves are detached from the unitary piece of material either by perforation, partial cut, print, tearing, or cutting of the plurality of attachment surfaces, thereby maintaining a structural integrity of the one or more identical frustoconical sleeves.

8. A method of assembling a frustoconical sleeve, the method comprising:
forming a three-dimensional frustoconical sleeve by engaging opposing top ends and bottom ends of a frustoconical sleeve to one another to define a bottom crevice whereby a lower void exists between a bottom end of an inserted cylindrical or conical container and a bottom edge of the frustoconical sleeve; and
attaching the opposing top ends and bottom ends of material to each other by applying adhesive to at least one of the opposing top and bottom ends.

9. The method of claim 8, further comprising:
forming the frustoconical sleeve from a unitary piece of material.

10. The method of claim 8, further comprising:
creating at least one fold along a perforated perimeter wall of the frustoconical sleeve to attach the opposing top ends and bottom ends of the frustoconical sleeve.

11. The method of claim 8, further comprising:
attaching a plurality of attachment surfaces to the frustoconical sleeve to enable multi-pack engagement of identical frustoconical sleeves.

12. The method of claim 11, further comprising:
attaching the plurality of attachment surfaces includes an adhesive material.

13. The method of claim 12, further comprising:
attaching the plurality of attachment surfaces includes interlocking tabs, structured board, or non-adhesive materials.

14. The method of claim 11, further comprising:
detaching at least one of the plurality of attachment surfaces from the frustoconical sleeve by perforation, partial cut, print, tearing, or cutting of the at least one of the plurality of attachment surfaces while maintaining a structural integrity of the frustoconical sleeve.

15. The method of claim 8, further comprising:
attaching at least two aligned sections of material partially cut on three sides from within opposing walls of the frustoconical sleeve to one another, whereby, upon opening the frustoconical sleeve, aligned sections hinge inwardly from the opposing walls of the frustoconical sleeve to form a horizontal bottom end whereby an inserted cylindrical or conical container is supported and therein prevented from passing through the frustoconical sleeve.

16. A sleeve for receiving a cylindrical beverage container, the sleeve comprising:
a top end;
a bottom end; and
a central surface area defined between the top end and the bottom end, wherein an exterior perimeter of the central surface area is formed by folding the central surface such that an upper diameter of the top end is greater than a lower diameter of the bottom end,
wherein the lower diameter of the bottom end is narrower than a lower diameter of an inserted cylindrical beverage container forming a lower void between a bottom end of the inserted cylindrical beverage container and a bottom edge of the sleeve.
